(19) United States
(12) Patent Application Publication
(10) Pub. No.: US 2007/0089505 A1
(43) Pub. Date: Apr. 26, 2007

(54) Liquid level control device

(76) Inventor: John Peterson, Henderson, NV (US)

Correspondence Address: TOPE-MCKAY & ASSOCIATES, 23852 PACIFIC COAST HIGHWAY #311, MALIBU, CA, 90265, US

(21) Appl. No.: 11/438,097

(22) Filed: May 17, 2006

Related U.S. Application Data
(60) Provisional application No. 60/682,245, filed on May 17, 2005.

(51) Int. Cl. G01F 23/00

(52) U.S. Cl. 73/313

(57) ABSTRACT

The present invention relates to a self-contained device to maintain a specific level of liquid in a pool, spa or other small body of water. More specifically, the invention relates to a self-contained mechanical device that can be detachably mounted to a spa at a desired level and maintain the level of liquid in that spa using a floatation device connected to a stopper via a lever arm. As liquid enters the device chamber through a liquid intake opening, the flotation device rises along with the level of liquid in the device. A liquid outlet opening allows the liquid in the device to exit into the spa to be maintained, thereby equalizing the level of liquid in the device and the spa. When the liquid rises to a desired level, the flotation device rises as well, pulling the lever arm and closing the stopper over the liquid intake opening.

### PRIORITY CLAIM

The present application claims the benefit of priority of U.S. Provisional Patent Application No. 60/682,245, filed May 17, 2005 and entitled “Liquid Level Control Device.”

### BACKGROUND OF THE INVENTION

(1) Technical Field

The present invention relates to a self-contained device to maintain a specific level of liquid in an enclosure. More specifically, the invention relates to a self-contained device that can be detachably mounted to a hot tub at a given level to maintain the level of liquid in the spa using a floatation device connected to a stopper via a lever arm.

(2) Background

There is a great need the water in above-ground, portable hot tubs and at a constant temperature. Generally a small, inline electric heating element keeps the water in the spa at a constant temperature. However, the water level in the spa drops over time, primarily due to evaporation of the hot water and splash-out from use. To fill the spa, cold water must be added, thus cooling the temperature of the water in the spa. Unfortunately, many heating elements require several hours to reheat the now cooled water in the spa, making the spa unpleasant and essentially unusable for a long period of time. In addition, low water level in a spa can cause the spa pump to run dry, which can burn out pump seals and cause extreme wear and tear to the spa.

Existing water leveling systems are primarily designed for swimming pools and have several limitations due to their intended use. Some systems use external overflow tanks with sensors in the tanks to determine the water level and adjust accordingly. Sensors for use with these systems are described in U.S. Pat. Nos. 5,804,080; 4,445,238; and 3,895,402. For most portable spa users, an external overflow tank is an unnecessary and expensive addition. For in-ground spas, the system is similarly expensive and must be implemented before spa installation or added on after initial installation; again at great expense.

More advanced systems for maintaining the level of water in pools and spas incorporate electronic sensors and transmitters. U.S. Pat. Nos. 5,878,447 and 6,718,567 both disclose electrical systems that detect low water levels with processors and transmitters and use radio frequencies to activate remote devices to maintain the water level of a pool. These systems, while effective, are not only expensive but require external power sources or batteries to operate. Additionally, power sources near pools and spas are dangerous if they should malfunction or waterproofing capabilities become compromised.

Therefore, a need exists in the art for a stand-alone, detachably mounted mechanical device which can continuously maintain the water level in a spa by causing water to be added when the level drops below a predetermined level and stop adding water when the water reaches a desired level.

### SUMMARY OF THE INVENTION

The present invention relates to a self-contained device to maintain a specific level of liquid in an enclosure. More specifically, the invention relates to a self-contained device that can be detachably mounted to a spa at a desired level and maintain the level of liquid in that spa using a floatation device connected to a stopper via a lever arm. As liquid enters a housing surrounding the device through a liquid intake opening, the flotation device rises along with the level of liquid in the housing. A liquid outlet opening allows the liquid in the housing to exit into the spa to be maintained, thereby equalizing the level of liquid in the housing and the spa. When the amount of liquid in the spa and the housing reaches a desired level, the flotation device is raised enough to engage and pull the lever arm, which in turn pulls the stopper over the liquid intake opening and prevents additional liquid from entering the housing. Once the amount of liquid in the housing drops below the desired level, the flotation device is lowered, releasing pressure on the lever, which, in turn, raises the stopper away from the inlet and allows additional liquid to enter the housing and thus the spa.

In one aspect, a liquid level control device for maintaining a level of liquid in an enclosure comprises a housing; a liquid intake opening in the housing for liquid to enter the housing; a stopper valve positioned over the liquid intake opening to stop the flow of liquid entering the device through the liquid intake opening; a liquid outlet opening for liquid to flow in and out of the housing from the enclosure; and a float-controlled stopper mechanism connected with the stopper valve to selectively allow liquid to enter the housing depending on the level of liquid in the enclosure.

In another aspect, the float-controlled stopper mechanism comprises a floatation device attached with a lever arm, the lever arm attached with a stopper such that when the level of liquid in the device rises to a certain level, the floatation device rises and pulls the lever arm, which pulls the stopper over a stopper valve opening and prevents liquid from entering the device.

In a further aspect, the housing further comprises an overflow opening in the housing to permit excess liquid to flow out of the housing.

In a yet further aspect, the liquid level control device further comprises a mounting bracket connected with the housing to adjustably mount the device to the side of an enclosure at the liquid level desired.

In a yet further aspect, a method for maintaining a constant level of liquid in an enclosure comprises the steps of placing a housing in the enclosure at the level of liquid to be maintained; permitting the housing to fill with liquid at a level that is equal to the level of liquid in the enclosure; attaching a liquid supply line to a liquid intake opening in the housing to selectively supply liquid to the housing; connecting a stopper valve to the liquid intake opening to prevent liquid from entering the housing; placing a selectively movable stopper over the stopper valve, wherein the stopper is connected with a lever arm that can be selectively moved between a first position that prevents liquid from entering through the stopper valve and a second position that permits liquid to enter through the stopper valve; and connecting the lever arm with a floatation device floating within the housing and above the level of liquid, such that the stopper prevents liquid from entering through the stopper valve when the liquid level in the enclosure is normal and the flotation device pulls the lever arm to the first position, and permitting liquid to enter through the stopper valve when the liquid level in the enclosure is below normal and the flotation device relaxes pressure on the level arm, allowing the level arm to move into the second position.

### BRIEF DESCRIPTION OF THE DRAWINGS

The objects, features and advantages of the present invention will be apparent from the following detailed descriptions of the disclosed aspects of the invention in conjunction with reference to the following drawings, where:

FIG. 1 is an illustration of one aspect of the present invention, depicting a housing containing the liquid level control device, a liquid intake opening, a liquid outlet opening, an overflow opening, and a pair of mounting brackets;

FIG. 2 is a deconstructed illustration of one aspect of the present invention, depicting all of the components of the liquid level control device, including a nut for connecting the liquid intake opening to a liquid supply hose; the housing along with the liquid intake opening, liquid outlet opening, overflow opening, and mounting bracket; a stopper valve; a lever arm; a flotation device and a cap;

FIG. 3 illustrates one aspect of the present invention, depicting the design of the stopper mechanism with the lever arm in a movable connection with the flotation device wherein the lever arm can be moved to engage the stopper with a liquid entry hole and prevent liquid from entering the chamber of the liquid level control device;

FIG. 4 is an illustration of one aspect of the present invention, depicting the lever arm with two openings on each end to insert connecting pins to connect the lever arm to the stopper mechanism and the flotation device; and

FIG. 5 is an illustration of one aspect of the present invention, depicting the liquid level control device in operation in a body of water.

### DETAILED DESCRIPTION

(1) Introduction

The present invention relates to a self-contained device to maintain a specific level of liquid in a hot tub, spa, pool or other body of water. More specifically, the invention relates to a self-contained device that can be detachably mounted to a spa at a desired level and maintain the level of liquid in that spa using a floatation device connected to a stopper via a lever arm. As liquid enters a housing surrounding the device through a liquid intake opening, the flotation device rises along with the level of liquid in the housing. A liquid outlet opening allows the liquid in the housing to exit into the spa to be maintained, thereby equalizing the level of liquid in the housing and the spa. When the amount of liquid in the spa and the housing reaches a desired level, the flotation device is raised enough to engage and pull the lever arm, which, in turn, pulls the stopper over the liquid intake opening and prevents additional liquid from entering the housing. Once the amount of liquid in the housing drops below the desired level, the flotation device is lowered, releasing pressure on the lever, which, in turn, raises the stopper away from the inlet and allows additional liquid to enter the housing and thus the spa.

The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents that are filed concurrently with this specification and are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(2) Function of the Liquid Level Control Device

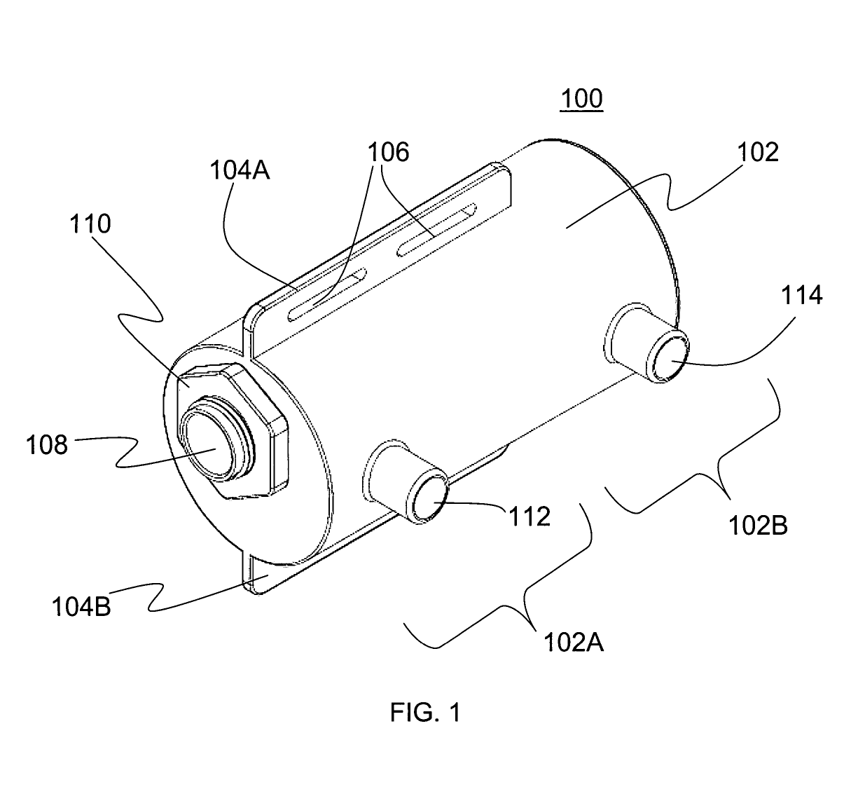

The liquid level control device is a self-contained device which can be easily mounted on the inside of a spa or other container of water to maintain a desired level of liquid. In one embodiment, as shown in FIG. 1, the liquid level control device 100 comprises a housing 102 that forms a chamber for containing liquid with a lower portion 102A and an upper portion 102B. Two rectangular mounting brackets 104A and 104B are attached to opposite sides of the housing 102 running vertically from the lower portion 102A to the upper portion 102B. The mounting brackets 104A and 104B contain elongated holes 106 so that the housing 102 can be adjusted up or down to easily adjust the desired liquid level. The lower portion 102A of the device contains a liquid intake opening 108, which receives liquid from an external source (not pictured). The liquid intake opening 108 extends outward from the housing 102 and is grooved to facilitate a connection with an external source through a hose. A nut 110 is attached to the liquid intake opening 108 to secure a hose to the device. A liquid outlet opening 112 is provided on the lower end of the housing 102A, and allows liquid in the chamber to exit into the spa. An overflow opening 114 is also located above the liquid outlet opening 112 to prevent an overflow of water in the chamber. In one embodiment, the overflow opening 114 is connected to a hose (not pictured) to prevent the excess liquid from spilling into the spa.

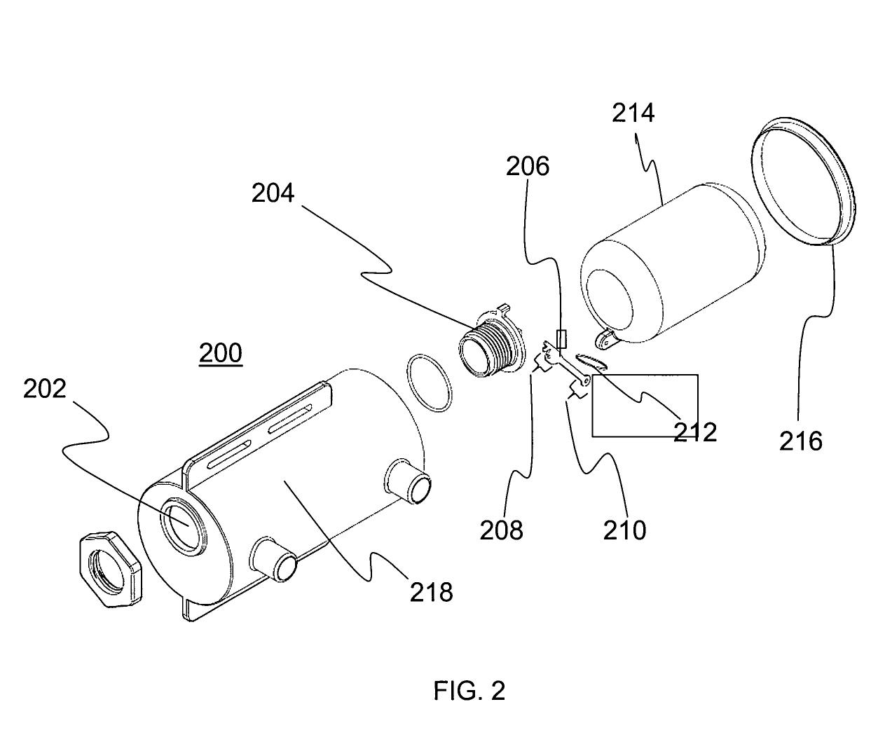

FIG. 2 is a deconstructed illustration of all of the components of the liquid level control device 200. The liquid intake opening 202 is directly connected to a stopper valve 204, which interacts with a stopper (not pictured) to prevent liquid from flowing through the stopper valve 204 and into the housing 200. A lever arm 206 is attached on a lower end 208 to the stopper and on an upper end 210 to a lever ring 212; and the lever ring 212 is attached to a flotation device 214. A removable cap 216 is provided in one embodiment to enclose the upper portion of the housing 218 and allow access to the chamber and internal components.

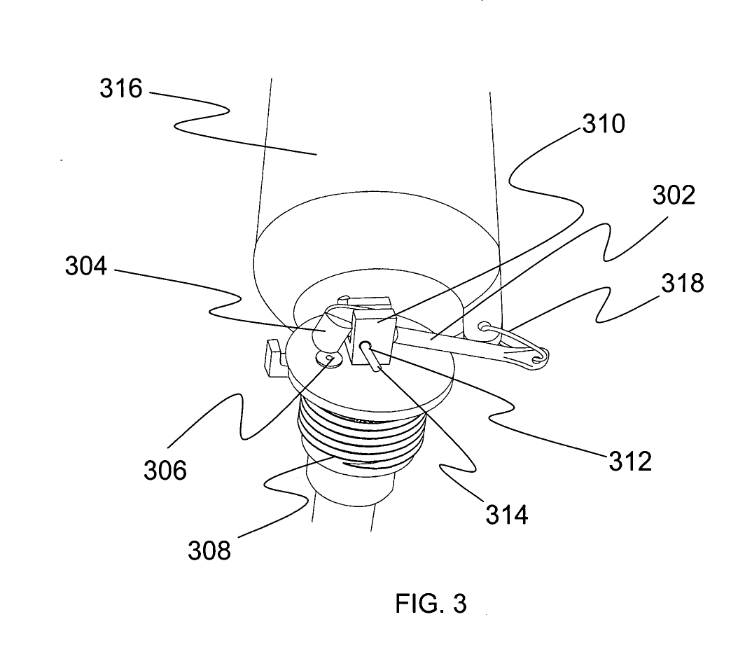

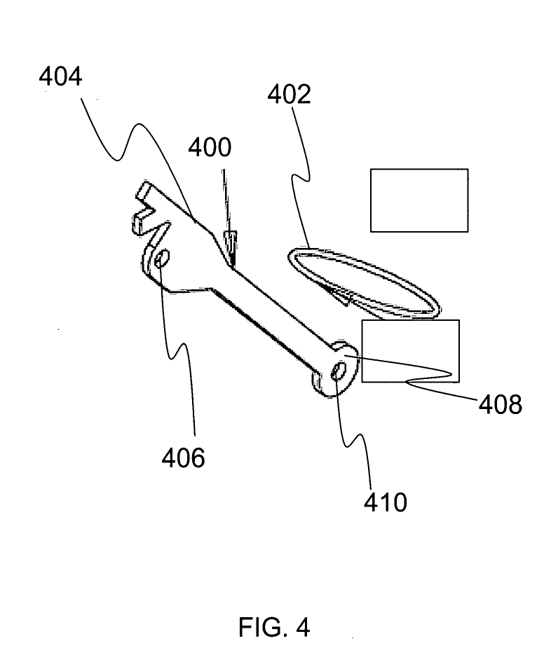

The stopper mechanism is shown in detail in FIG. 3, illustrating how the lever arm 302 with a stopper end 302A and non-stopper end 302B is connected with the stopper 304 that will cover a liquid entry hole 306 to prevent liquid from entering the device. The stopper valve 308 further comprises a u-shaped lever mount 310 with a groove to fit the lever arm 302. The lever mount 310 further comprises a pinhole 312 protruding through the sides of the lever mount 310, which aligns with a pinhole in the lever arm (as shown in FIG. 4). A pin 314 is then inserted through the lever mount 310 and corresponding pinhole in the lever arm to lock the lever arm 302 in place. The lever arm 302 is connected with the floatation device 316 on the non-stopper end 302B of the stopper 304 via a lever ring 318, which allows the lever arm 302 to move freely from a closed position where the stopper 304 prevents liquid from entering through the liquid entry hole 306 to an open position where the stopper 304 is moved away from the liquid entry hole and liquid can flow freely into the housing. When the liquid level in the housing is high, the flotation device 316 floats to the top of the housing and away from the stopper mechanism, pulling the non-stopper end toward the flotation device 316 via the lever ring 318. This in turn pulls the stopper 304 downward onto the liquid entry hole 306 to prevent liquid from entering the device. However, when the liquid level drops, the flotation device 316 floats closer to the stopper mechanism, releasing the pulling force on the non-stopper end of the lever arm 302 and allowing the stopper 304 to pull away from the liquid entry hole 306 and allowing liquid to enter the device.

The lever arm 400 and lever ring 402 are shown in detail in FIG. 4. At the stopper end 404 of the lever arm 400, a small pinhole 406 is created to attach the lever arm 400 with the stopper valve (not pictured) through the lever mount 310 (as shown in FIG. 3). At the non-stopper end 408 of the lever arm 400, a second pinhole 410 is created to insert the lever ring 402. The lever ring 402 is also connected to the flotation device (not pictured), thus enabling the flotation device to move the lever arm 400 up or down depending on the level of liquid in the device; the movement of the lever arm 400, in turn, moves the stopper to either allow liquid or prevent liquid from entering the device.

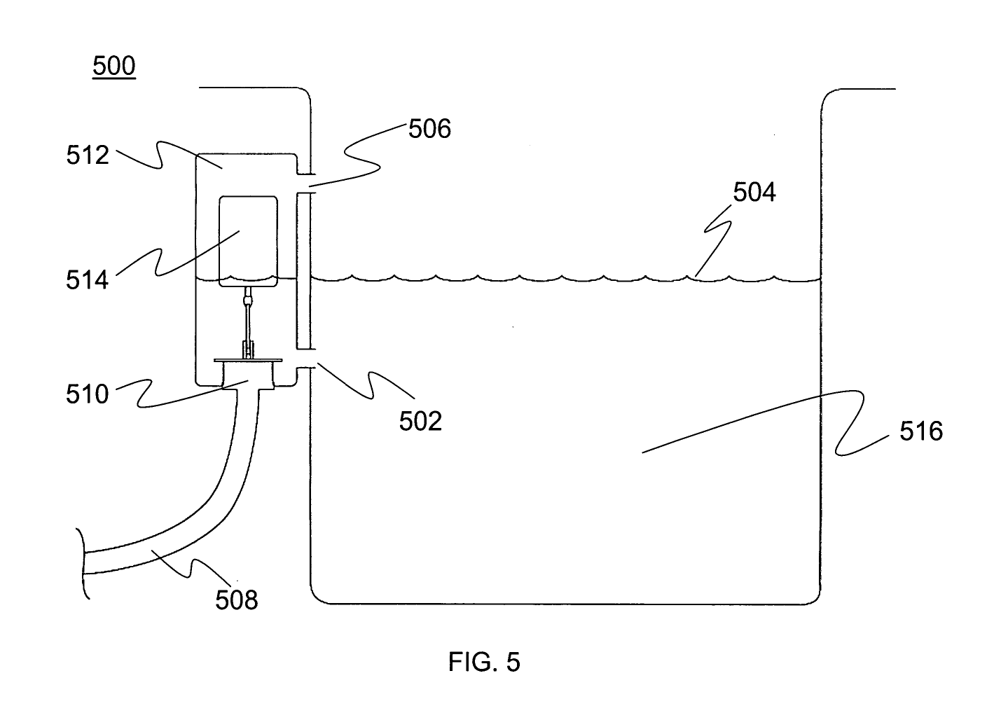

FIG. 5 illustrates the liquid level control device 500 in use in a body of water 516. The device 500 is mounted to the side wall at a height where the water level should be maintained. Specifically, the liquid outlet opening 502 is placed slightly below the desired water level 504, and the overflow opening 506 is placed slightly above the desired water level. A water source, such as a hose 508, is hooked up to the liquid intake opening 510 to provide water to the device 500. Water initially flows into the device chamber 512 by equilibrium through the liquid outlet opening 502, which causes the flotation device 514 to rise, pulling the non-stopper end 302B (see FIG. 3) of the lever arm 302 upward and the stopper end 302A (see FIG. 3) of the lever arm 302 downward such that the stopper 304 is forced over the liquid entry hole 306 (see FIG. 3). However, once the water level in the body of water 516 begins to diminish, the flotation device 514 will sink along with the water level, relieving the force on the non-stopper end 302B of the lever arm 302 and raising the stopper end 302A of the lever arm 302 (see FIG. 3). When the stopper end 302A of the lever arm 302 rises, water from the hose 508 will flow into the chamber 512 and, by equilibrium, into the body of water 516.

One skilled in the art will appreciate that the liquid level control device is not limited to applications such as for recreational spas and pools, but can be applied to any reasonably-sized body or container of water where a level of liquid needs to be maintained. The scale of the device can be easily adjusted to accommodate a larger body of water such as a pool or even small pond for livestock, as well as a smaller body of water, such as a water trough or sink.

The liquid level control device, in one non-limiting embodiment, is comprised mainly of plastic, including the housing, flotation device and stopper valve. The stopper is comprised of rubber to provide a tighter seal when in contact with the liquid entry hole, and the lever arm and lever ring can be made of a more durable plastic or even a metal such as aluminum, as long as its weight does not compromise the function of the stopper mechanism.

What is claimed is:

1. A liquid level control device for maintaining a level of liquid in an enclosure, the liquid level control device comprising:
a housing;
a liquid intake opening in the housing for liquid to enter the housing;
a stopper valve positioned over the liquid intake opening to stop the flow of liquid entering the device through the liquid intake opening;
a liquid outlet opening for liquid to flow in and out of the housing from the enclosure; and
a float-controlled stopper mechanism connected with the stopper valve to selectively allow liquid to enter the housing depending on the level of liquid in the enclosure.

2. The liquid level control device of claim 1, wherein the float-controlled stopper mechanism comprises a floatation device attached with a lever arm, the lever arm attached with a stopper such that when the level of liquid in the device rises to a certain level, the floatation device rises and pulls the lever arm, which pulls the stopper over a stopper valve opening and prevents liquid from entering the device.

3. The liquid level control device of claim 2, wherein the housing further comprises an overflow opening in the housing to permit excess liquid to flow out of the housing.

4. The liquid level control device of claim 3, further comprising a mounting bracket connected with the housing to adjustably mount the device to the side of an enclosure at the liquid level desired.

5. A method for maintaining a constant level of liquid in an enclosure, comprising the steps of:
placing a housing in the enclosure at the level of liquid to be maintained;
permitting the housing to fill with liquid at a level that is equal to the level of liquid in the enclosure;
attaching a liquid supply line to a liquid intake opening in the housing to selectively supply liquid to the housing;
connecting a stopper valve to the liquid intake opening to prevent liquid from entering the housing;
placing a selectively movable stopper over the stopper valve, wherein the stopper is connected with a lever arm that can be selectively moved between a first position that prevents liquid from entering through the stopper valve and a second position that permits liquid to enter through the stopper valve; and
connecting the lever arm with a floatation device floating within the housing and above the level of liquid, such that the stopper prevents liquid from entering through the stopper valve when the liquid level in the enclosure is normal and the flotation device pulls the lever arm to the first position, and permitting liquid to enter through the stopper valve when the liquid level in the enclosure is below normal and the flotation device relaxes pressure on the level arm, allowing the level arm to move into the second position.
